(19) United States
(12) Patent Application Publication
(10) Pub. No.: US 2025/0284913 A1
(43) Pub. Date: Sep. 11, 2025

(54) PRINTING SYSTEM AND METHOD FOR INSPECTING PRINT PRODUCT

(71) Applicant: Konica Minolta, Inc., Tokyo (JP)

(72) Inventor: Tamotsu SAKURABA, Sagamihara-shi (JP)

(21) Appl. No.: 19/071,275

(22) Filed: Mar. 5, 2025

(30) Foreign Application Priority Data
Mar. 11, 2024 (JP) 2024-037475

(51) Int. Cl. G06K 15/02; B41J 3/46; B41J 11/00; G06K 15/00; G06T 7/00

(52) U.S. Cl. CPC G06K 15/027; B41J 3/46; B41J 11/008; G06K 15/007; G06T 7/0004; G06K 2215/101; G06T 2207/30144

(57) ABSTRACT

Disclosed is a printing system including: a printing section that produces a print product by printing an image on a recording material by an inkjet method; a reading section that reads the image printed by the printing section on the recording material; a hardware processor that stores a plurality of reference candidate images which is formed by the printing section printing a plurality of reference candidates for inspecting the print product and the reading section reading the printed plurality of reference candidates without waiting for ink stabilization of the plurality of reference candidates, and registers a reference candidate image selected from the plurality of reference candidate images as a reference image for inspecting the print product; and an inspection section that, without waiting for the ink stabilization of the print product, inspects the print product by collating the read image of the print product with the reference image.

### TECHNICAL FIELD

The present invention relates to a printing system and a method for inspecting a print product.

### DESCRIPTION OF RELATED ART

Conventionally, in an inspection system mounted on an inkjet printer, a plurality of reference images is printed and output with a plurality of printing condition settings while changing the printing condition settings of the reference image. In an image on a printing sheet output by the inkjet printer, ink is not stabilized until several tens of minutes elapse. Therefore, after the ink of the plurality of printed reference images is stabilized, a reference image for inspection is selected from the plurality of ink-stabilized reference images. For example, JP 2010-241061A discloses a technique in which a time longer than a color stabilization time of ink is set as a drying time, and colorimetry is started after the drying time has elapsed.

In JP 2010-241061A, it is described that the color stabilization time of ink to be used is acquired. Furthermore, it is described that at least a time longer than the color stabilization time is defined as the drying time. Furthermore, it is described that colorimetry by a colorimetry means is started after waiting for the drying time to elapse after a colored image is printed.

### SUMMARY OF THE INVENTION

As described above, conventionally, a technique has been disclosed in which the colorimetry is started after waiting for the drying time of ink to elapse. However, in the technique described in JP 2010-241061A, the reference image is determined after waiting for the drying time of the ink of the plurality of printed reference images. After that, the technique described in JP 2010-241061A waits for the drying time of the ink of the print product to be inspected and performs the colorimetry using the determined reference image. Therefore, there is a problem in that the inspection time of the print product becomes long and the efficiency of the inspection work decreases.

The present invention has been made to solve the above-described problem, and objects of the present invention include shortening the inspection time of a print product and improving the efficiency of inspection work.

To achieve at least one of the abovementioned objects, a printing system reflecting one aspect of the present invention comprises: a printing section that produces a print product by printing an image on a recording material by an inkjet method; a reading section that reads the image printed by the printing section on the recording material; a hardware processor that stores a plurality of reference candidate images which is formed by the printing section printing a plurality of reference candidates for inspecting the print product and the reading section reading the printed plurality of reference candidates without waiting for ink stabilization of the plurality of reference candidates, and registers a reference candidate image selected from the plurality of reference candidate images as a reference image for inspecting the print product; and an inspection section that, without waiting for the ink stabilization of the print product, inspects the print product by collating the read image of the print product with the reference image.

To achieve at least one of the abovementioned objects, a method that reflects another aspect of the present invention for inspecting a print product in a printing system including: a printing section that produces the print product by printing an image on a recording material by an inkjet method; and a reading section that reads the image printed by the printing section on the recording material, comprises: storing a plurality of reference candidate images which is formed by the printing section printing a plurality of reference candidates for inspecting the print product and the reading section reading the printed plurality of reference candidates without waiting for ink stabilization of the plurality of reference candidates; registering a reference candidate image selected from the plurality of reference candidate images as a reference image for inspecting the print product; and, without waiting for the ink stabilization of the print product, inspecting the print product by collating the read image of the print product with the reference image of the print product.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram illustrating a schematic configuration of a printing system according to an embodiment of the present invention;

FIG. 2 is a diagram illustrating a hardware configuration of an inkjet printer according to the embodiment of the present invention;

FIG. 3 is a diagram illustrating a job selection screen in the printing system according to the embodiment of the present invention;

FIG. 4 is a diagram illustrating an inspection mode setting screen in the printing system according to the embodiment of the present invention;

FIG. 5 is a diagram illustrating a reference image setting reminder screen in the printing system according to the embodiment of the present invention;

FIG. 6 is a diagram illustrating a reference candidate image selection screen in the printing system according to the embodiment of the present invention;

FIG. 7 is a diagram illustrating the inspection mode setting screen in the printing system according to the embodiment of the present invention;

FIG. 8 is a diagram illustrating an inspection print job setting screen in the printing system according to the embodiment of the present invention;

FIG. 9 is a diagram illustrating a setting change warning screen in the printing system according to the embodiment of the present invention;

FIG. 10 is a diagram illustrating an ink-stabilized reference image registration reminder screen in the printing system according to the embodiment of the present invention;

FIG. 11 is a diagram illustrating an ink-stabilized reference image registration screen in the printing system according to the embodiment of the present invention;

FIG. 12 is a flowchart illustrating a procedure of a reference candidate image registration process in the printing system according to the embodiment of the present invention;

FIG. 13 is a flowchart illustrating a procedure of a reference image selection process in the printing system according to the embodiment of the present invention; and

FIG. 14 is a flowchart illustrating a procedure of a print product inspection process in the printing system according to the embodiment of the present invention.

### DETAILED DESCRIPTION

Hereinafter, one or more embodiments of the present invention will be described with reference to the drawings. However, the scope of the invention is not limited to the disclosed embodiments. In the present specification and drawings, constituent elements having substantially the same function or configuration are denoted by the same reference numerals, and redundant descriptions of the constituent elements are omitted.

### One Embodiment

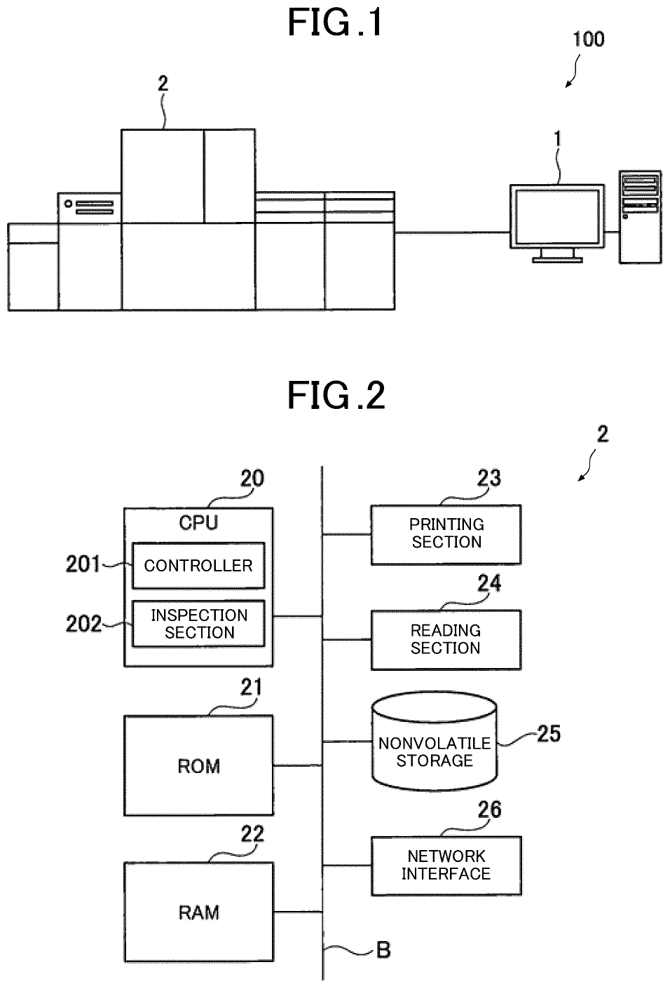

First, a schematic configuration of a printing system according to an embodiment of the present invention will be described. FIG. 1 is a diagram illustrating the schematic configuration of the printing system 100 according to the present embodiment. As illustrated in FIG. 1, the printing system 100 includes a printer controller 1 and an inkjet printer 2. The printer controller 1 and the inkjet printer 2 are coupled to each other via a network (not illustrated).

The printer controller 1 is a terminal device used by an operator to perform a printing operation, an inspection operation, and the like. The printer controller 1 includes a user interface with which the operator performs various settings. The user interface allows the operator to set a print job (printing condition setting), select a reference candidate image for print product inspection, and the like. The printer controller 1 transmits information such as a print job and an inspection setting set by the operator to the inkjet printer 2.

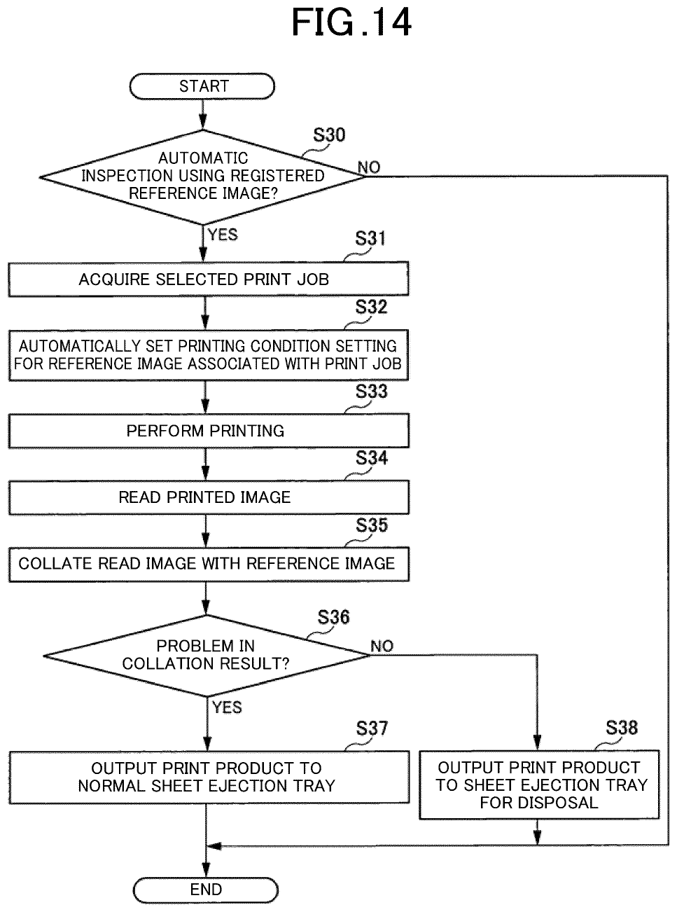

The inkjet printer 2 receives the information such as a print job and an inspection setting transmitted from the printer controller 1. The inkjet printer 2 prints an image on a recording material, such as a sheet, by an inkjet method according to the printing condition set in the print job. In addition, the inkjet printer 2 performs an automatic inspection process (see FIG. 14, which will be described later) on the output print product.

### Example of Hardware Configuration of Inkjet Printer

Next, an example of a hardware configuration of the inkjet printer 2 will be described. FIG. 2 is a diagram illustrating the hardware configuration of the inkjet printer 2.

As illustrated in FIG. 2, the inkjet printer 2 includes a central processing unit (CPU) 20, a read only memory (ROM) 21, and a random-access memory (RAM) 22, each coupled to a bus B. The inkjet printer 2 also includes a printing section 23, a reading section 24, a nonvolatile storage 25, and a network interface 26. In FIG. 2, only the components related to the present embodiment are shown, and illustration and description of the other components are omitted.

The CPU 20 reads, from the ROM 21, a program code of software that implements each function of the inkjet printer 2, loads the program code into the RAM 22, and executes the program code. In the RAM 22, variables, parameters, and the like generated during arithmetic processing of the CPU 20 are temporarily written, and these variables, parameters, and the like are read as needed by the CPU 20. However, a micro processing unit (MPU) may be used in place of the CPU 20. As illustrated in FIG. 2, the CPU 20 implements the functions of a controller (hardware processor) 201 and an inspection section 202.

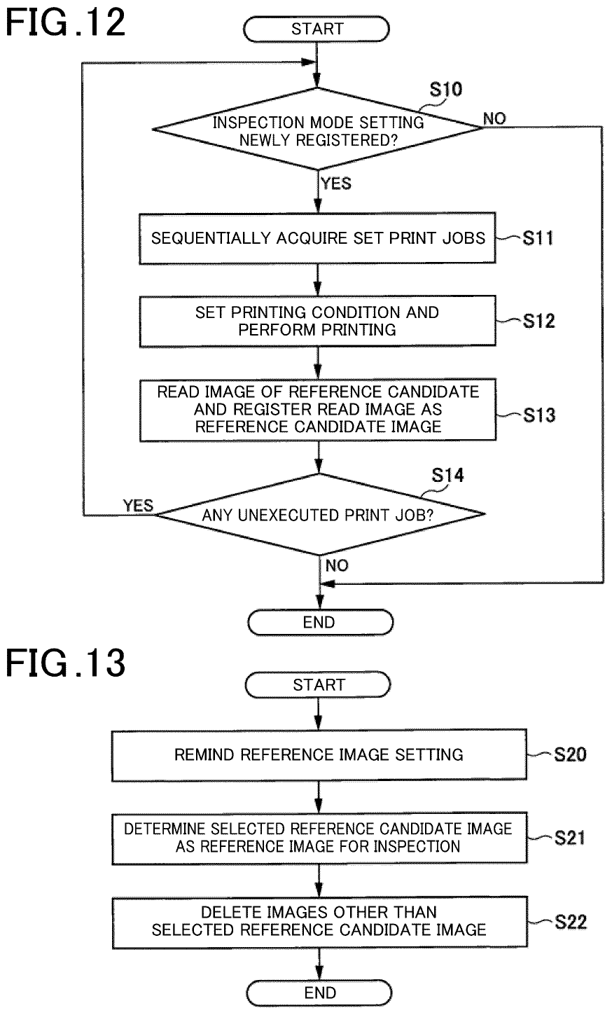

The controller 201 controls the operation of each component of the inkjet printer 2 such as the printing section 23 and the reading section 24. The controller 201 controls printing processing in the printing section 23. Further, without waiting for the ink stabilization of a plurality of reference candidates printed by the printing section 23 for inspecting a print product, the controller 201 stores images of the plurality of reference candidates read by the reading section 24 as a plurality of reference candidate images. The controller 201 also registers a reference candidate image selected from the plurality of reference candidate images as a reference image Note that reference candidate image registration process and reference image selection process will be described in detail later with reference to FIGS. 12 and 13, respectively.

The inspection section 202 inspects the print product by collating the read image of the print product with the reference image of the print product without waiting for the ink stabilization of the print product.

The printing section 23 has a function of printing an image on a recording material by an inkjet method. The reading section 24 is an example of an image reading device including an image sensor and the like. The reading section 24 reads an image printed on a recording material, and outputs the read image.

As the nonvolatile storage 25, for example, a hard disk drive (HDD), a solid-state drive (SSD), a flexible disk, an optical disk, a magneto-optical disk, a CD-ROM, a CD-R, a magnetic tape, a nonvolatile memory, or the like is used. The nonvolatile storage 25 stores, in addition to an operating system (OS) and various parameters, programs that causes the inkjet printer 2 to function. The ROM 21 and the nonvolatile storage 25 record the programs, data, and the like necessary for the CPU 20 to operate. The ROM 21 and the nonvolatile storage 25 are used as an example of computer-readable non-transitory recording media storing programs.

For example, a network interface card (NIC) or the like is used as the network interface 26. The network interface 26 can transmit and receive various types of data between devices via a local area network (LAN), a dedicated line, or the like coupled to a terminal of the NIC.

FIG. 2 illustrates a configuration in which the print product inspection function is an internal function of the inkjet printer 2, but the present invention is not limited thereto. For example, a device including the components other than the printing section 23 illustrated in FIG. 2 may be provided outside the inkjet printer 2 and used as a print product inspection device that inspects a print product.

### Examples of Various User Setting Screens

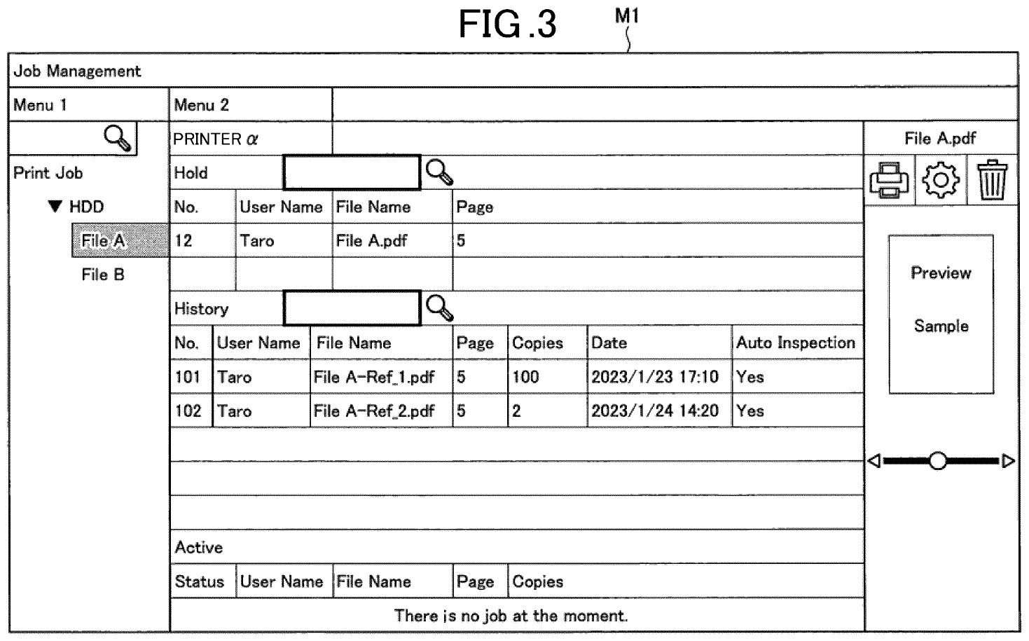

Next, examples of various user interfaces, that is, various user setting screens in the printing system 100 will be described. The various user setting screens are displayed on a display of the printer controller 1. FIG. 3 is a diagram illustrating a job selection screen M1 in the printing system 100 according to the present embodiment.

The name of the print job management file of each print product stored in the HDD of the printer controller 1 is displayed in a “Print Job” display portion on the left side of the job selection screen M1. In the “Print Job” display portion, for example, a file name such as “File A” and “File B”, that is, identification information of each print product is displayed. The management file includes management information on print jobs that have not been executed, have been executed, and are being executed for document images of the print product.

When one of the management files displayed on the job selection screen MI is selected, the management information on the print jobs to be associated with the print product is displayed at the center of the screen. In the present embodiment, the print jobs to be associated with the print product are print jobs to be associated with the respective plurality of reference candidates from which a reference image for inspection is selected. Each reference candidate is obtained by adjusting the printing condition setting and printing the document image with the adjusted printing condition setting.

As illustrated in FIG. 3, “printer a”, which is identification information of a printer specified in the print jobs, is displayed at the center of the job selection screen M1. Note that the identification information of a printer is not limited to the name of the printer, but may be an identification (ID), an Internet protocol (IP) address, or the like of the printer.

Furthermore, as illustrated in the drawing, under the identification information of the printer, the management information on the print jobs that have not been executed is displayed in a “Hold” display portion. In the “Hold” display portion, information of “No.”, “User Name”, “File Name”, and “Page” of each unexecuted print job is displayed. The “No.” is a management number (an example of identification information) of the print job. The “User Name” is a name (an example of identification information) of a user who has set the print job. The “File Name” is the identification information of the print product to be associated with the corresponding print job. The “Page” is the number of pages to be printed that is set in the print job.

Under the “Hold” display portion, the management information on the print jobs that have been executed is displayed in a “History” display portion. In the “History” display portion, information of “No.”, “User Name”, “File Name”, and “Page” of each executed print job is displayed. The various pieces of information above are the same as the various pieces of information displayed in the “Hold” display portion, and therefore, redundant descriptions are omitted. Furthermore, in the “History” display portion, information of “Copies”, “Date”, and “Auto Inspection” of each executed print job is displayed. The “Copies” is the number of copies to be printed that is set for the print job. The “Date” is date and time information when the print job was performed. The “Auto Inspection” is, for example, setting information for performing automatic inspection (e.g., “Yes”) or setting information for not performing automatic inspection (e.g., “No”).

Under the “History” display portion, the management information on the print jobs that are being executed is displayed in an “Active” display portion. In the “Active” display portion, information of “Status”, “User Name”, “File Name”, and “Page” of each in-execution print job is displayed. The various pieces of information other than “Status” are the same as the various pieces of information displayed in the “History” display portion, and therefore, redundant descriptions are omitted. The “Status” is information indicating the progress or the like of each in-execution print job.

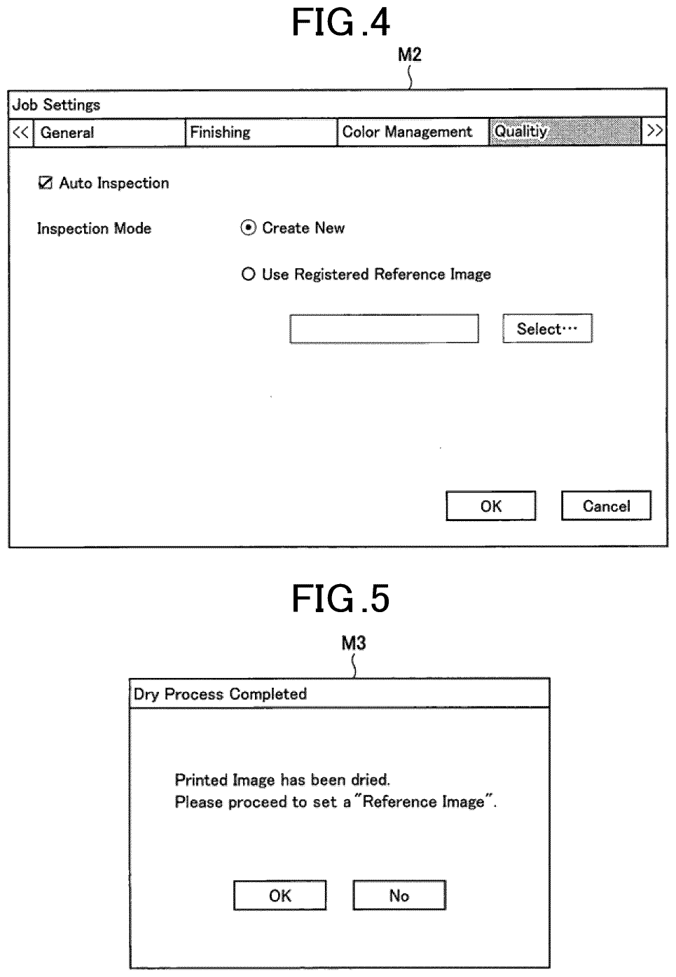

Next, setting screens related to new registration of a reference candidate image will be described. In the present embodiment, to select a reference image for inspection, the operator first sets the inkjet printer 2 to an inspection mode. FIG. 4 is a diagram illustrating an inspection mode setting screen M2 in the printing system 100 according to the present embodiment.

The inspection mode setting screen M2 displays an automatic inspection setting portion (a check box of “Auto Inspection” shown in the drawing). When the check box of “Auto Inspection” is selected, automatic inspection is set.

An inspection mode setting portion (“Inspection Mode”) is displayed under the automatic inspection setting portion. The inspection mode setting portion includes a new registration setting portion (radio button of “Create New”) and an inspection setting portion for using a registered reference image. The inspection setting portion includes a radio button of “Use Registered Reference Image” and a reference image selection portion.

In a case where the operator newly registers a reference candidate image, when the operator selects the radio button of “Create New” and presses an “OK” button, a print job setting screen (see FIG. 8 to be described later) is displayed. The operator adjusts the printing condition setting on the print job setting screen and executes printing in order to inspect a print product. The controller 201 manages a plurality of printing condition settings for inspecting a print product. The controller 201 controls the printing section 23 so that a plurality of reference candidates are printed by automatically setting the respective plurality of printing condition settings. The reading section 24 of the inkjet printer 2 reads the image of each reference candidate without waiting for the ink stabilization of the printed reference candidate. Then, the controller 201 registers the reference candidate image and the printing condition setting for printing the reference candidate image in the nonvolatile storage 25 in association with the print product.

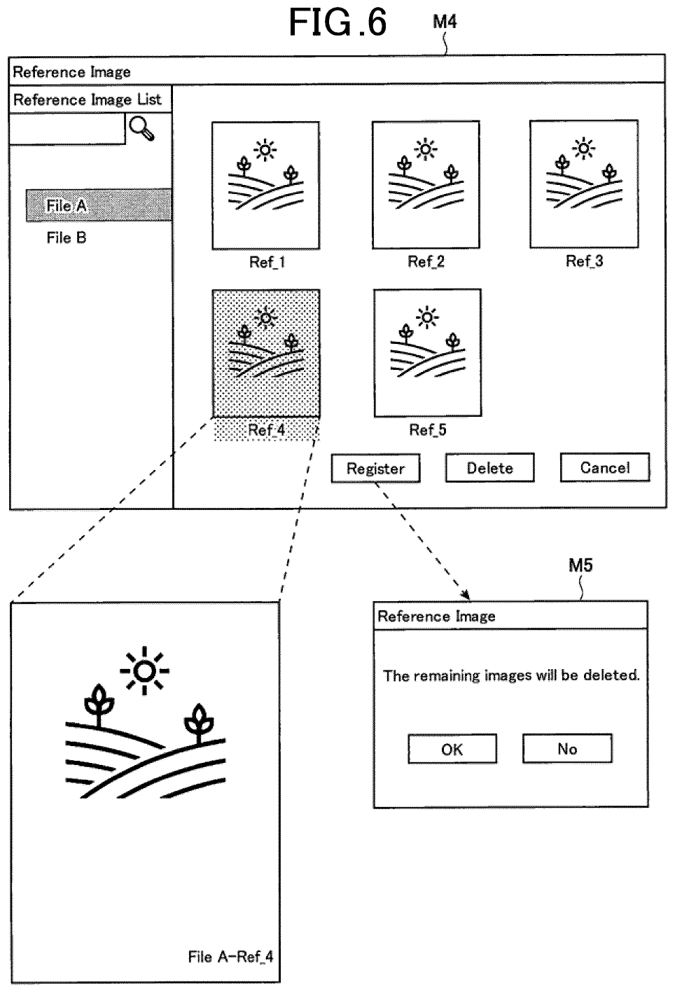

In the present embodiment, the user interface displays a reminder to select a reference image after a predetermined time for the ink stabilization of the plurality of reference candidates has elapsed. FIG. 5 is a diagram illustrating a reference image setting reminder screen M3 in the printing system 100 according to the present embodiment. As illustrated in FIG. 5, the reference image setting reminder screen M3 displays, for example, “Printed Image has been dried. Please proceed to set a “Reference Image”.” as a message prompting the user to set a reference image. When an “OK” button in the reference image setting reminder screen M3 is pressed, a reference candidate image selection screen M4 illustrated in FIG. 6 described later is displayed. Further, the reference image setting reminder screen M3 is closed. When a “No” button is pressed, the reference image setting reminder screen M3 is closed.

FIG. 6 is a diagram illustrating the reference candidate image selection screen in the printing system according to the present embodiment. As illustrated in FIG. 6, the name of the print job management file of each print product is displayed on the left side of the reference candidate image selection screen M4. When one of the displayed management files is selected, the reference candidate image selection screen M4 displays, on the right, reduced images of the plurality of reference candidate images to be associated with the print product.

The operator checks the reference candidates in which the ink is stabilized (see “File A-Ref_4” below left), and determines, for example, the fourth reference candidate (“Ref_4”) as the reference for inspection. In the present embodiment, the controller 201 controls the printing section 23 so that identification information of the reference candidate is printed in the margin of the reference candidate, as shown in “File A-Ref_4” below left. The operator can accurately select the candidate image on the reference candidate image selection screen M4 based on the identification information printed in the margin of the determined reference candidate. Note that the identification information of the reference candidate is, for example, the ID of the print job of the reference candidate. The identification information of the reference candidate may be arbitrary as long as it corresponds to identification information of the reference candidate image displayed on the reference candidate image selection screen M4.

Next, the operator selects the reference candidate image “Ref_4” on the reference candidate image selection screen M4 and presses a “Register” button. When the “Register” button is pressed, a deletion notice screen M5 is displayed as indicated by a dashed arrow. The deletion notice screen M5 is a screen for notifying that the reference candidate images other than the registered reference candidate image will be deleted. On the deletion notice screen M5, for example, a message “The remaining images will be deleted.” is displayed. When an “OK” button on the deletion notice screen M5 is pressed, the reference candidate images other than the selected target are deleted. Further, the selected reference candidate image (“Ref_4”) is registered as the reference image for inspection. When the reference image is registered, the reference image and the printing condition setting for printing the image are stored in association with the identification information of the print product. When a “No” button in the deletion notice screen M5 is pressed, the screen returns to the reference candidate image selection screen M4.

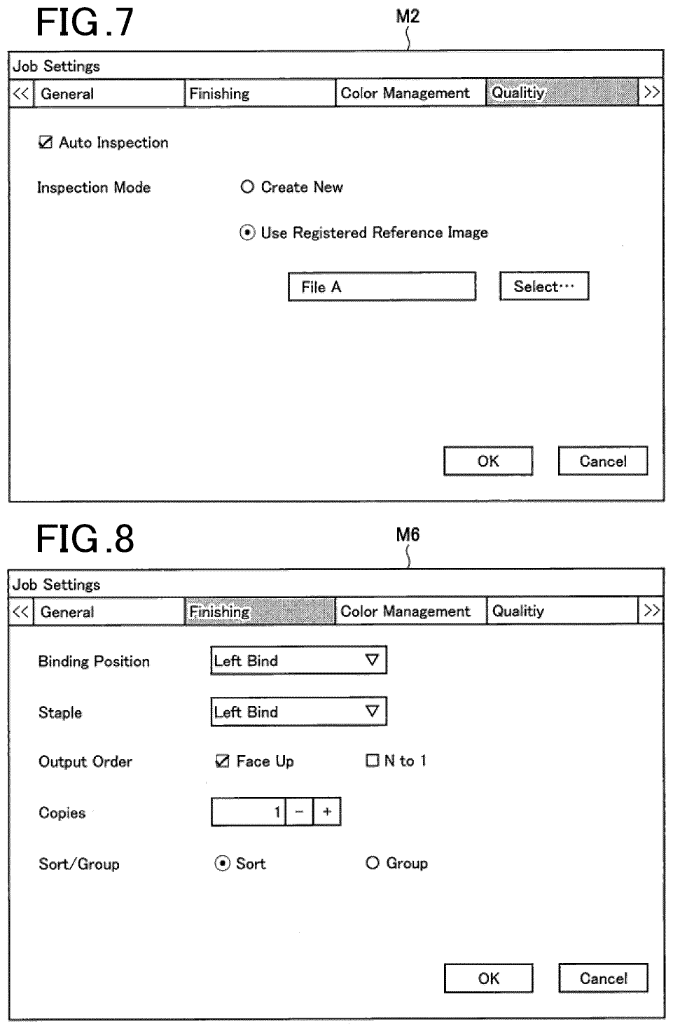

Next, inspection setting screens according to the present embodiment will be described. FIG. 7 is a diagram illustrating the inspection mode setting screen M2 in the printing system 100 according to the present embodiment. The configuration of the inspection mode setting screen M2 illustrated in FIG. 7 is the same as the configuration described with reference to FIG. 4, and therefore, redundant description is omitted.

After the reference image for inspection of the print product is registered, when performing the inspection, the operator selects the check box of “Auto Inspection” as shown in FIG. 7. The operator also selects the radio button of “Use Registered Reference Image”. The operator also selects, in the reference image selection portion, the print job management file of the print product to be inspected. In the reference image selection portion, when a “Select . . . ” button is pressed, the storage location of the print job management files of the respective print products is opened. When the management file of the print product to be inspected is selected from among the management files, the name of the selected management file is reflected in a text box. When the “OK” button is pressed, an inspection print job setting screen is displayed.

FIG. 8 is a diagram illustrating the inspection print job setting screen M6 in the printing system 100 according to the present embodiment. The setting items of the inspection print job setting screen M6 are the same as the conventional setting items of a print job, and a detailed description thereof is omitted here. In the present embodiment, the controller 201 automatically sets the printing condition setting for printing the reference candidate image selected as the reference image. Therefore, the printing condition setting for printing the selected reference candidate image are automatically written and displayed on the inspection print job setting screen M6. When the operator checks the items of the inspection print job setting screen M6 and does not make any changes, the operator presses an “OK” button. The printing section 23 then prints under the automatically set printing condition setting and outputs a print product. The print product is automatically inspected based on the reference image associated with the management file name selected on the inspection mode setting screen M2.

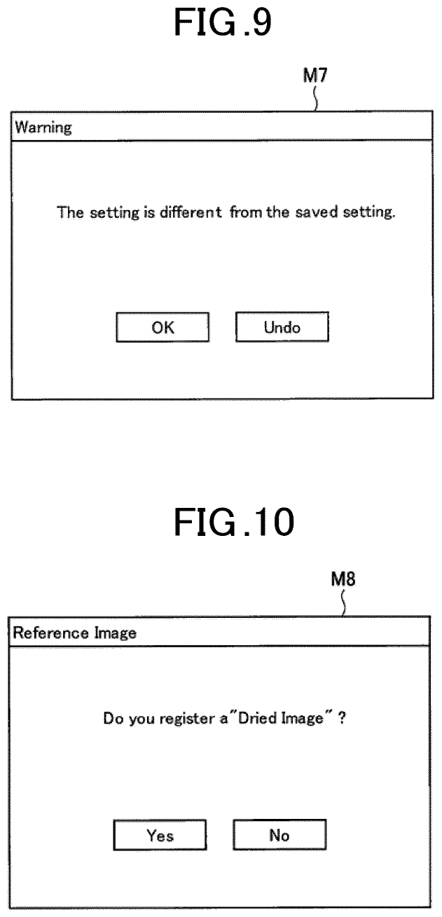

When the operator checks the items of the inspection print job setting screen M6, changes the printing condition setting, and presses the “OK” button, a setting change warning screen is displayed. That is, the user interface displays a warning when the printing condition setting for printing the print product is different from the automatically set printing condition setting. FIG. 9 is a diagram illustrating the setting change warning screen M7 in the printing system 100 according to the present embodiment. On the setting change warning screen M7, for example, a warning message “The setting is different from the saved setting.” is displayed. When the operator presses an “OK” button, the changed printing condition setting is applied. When the operator presses an “Undo” button, the setting change is cancelled and the screen is returned to the inspection print job setting screen M6.

After the settings on the above-described various user setting screens have been set, the automatic inspection process for the print product is started. In the present embodiment, the user interface displays a reminder to register an ink-stabilized reference image after the inspection of the print product. FIG. 10 is a diagram illustrating an ink-stabilized reference image registration reminder screen M8 in the printing system 100 according to the present embodiment.

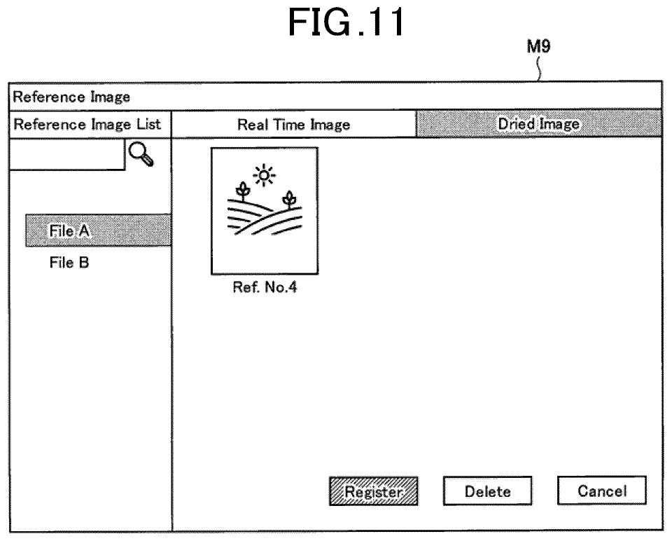

As illustrated in FIG. 10, for example, a reminder message “Do you register “Dried Image”?” is displayed on the ink-stabilized reference image registration reminder screen M8. When the operator presses a “Yes” button, a dried reference image registration screen M9, as illustrated in FIG. 11, is displayed.

FIG. 11 is a diagram illustrating the ink-stabilized (dried) reference image registration screen M9 in the printing system 100 according to the present embodiment. On the left side of the dried reference image registration screen M9, the name of the print job management file of each print product is displayed. When one of the displayed management files is selected, either undried reference images (“Real Time Image”) or dried reference images (“Dried Image”) associated with the print product can be selected to be displayed on the right side. In FIG. 11, a reduced image of the dried reference image is displayed. When the operator presses a “Register” button, the dried reference image is registered in association with the print product. Registering an ink-stabilized reference image allows the ink-stabilized reference image to be used for inspection of a print product produced by another inkjet printer.

### Procedure of Reference Candidate Image Registration Process

Next, a procedure of a reference candidate image registration process in the printing system 100 will be described. FIG. 12 is a flowchart illustrating the procedure of the reference candidate image registration process in the printing system 100 according to the present embodiment. Here, it is assumed that the operator has selected a print job on the job selection screen M1 (see FIG. 3). It is also assumed that the operator has set a plurality of print jobs in order to adjust the printing condition setting and print a plurality of reference candidates. When the operator performs the new registration operation described with reference to FIG. 4 on the inspection mode setting screen M2 (see FIG. 4), the following process is started.

First, the controller 201 of the inkjet printer 2 determines whether the inspection mode setting is newly registered (S10).

If the controller 201 determines that the inspection mode setting is not newly registered (NO in S10), the controller 201 ends the reference candidate image registration process.

On the other hand, if the controller 201 determines that the inspection mode setting is newly registered (YES in S10), the controller 201 sequentially acquires the set print jobs (S11).

Next, the controller 201 of the inkjet printer 2 sets printing conditions according to the print jobs, and the printing section 23 performs printing (S12).

Next, the reading section 24 of the inkjet printer 2 reads the printed image of each reference candidate and registers the read image as a reference candidate image (S13).

Next, the controller 201 of the inkjet printer 2 determines whether there is an unexecuted print job (S14).

If the controller 201 determines that there is an unexecuted print job (YES in S14), the controller 201 returns the process to step S1 and repeatedly executes the processing from steps S10 to S14.

On the other hand, if the controller 201 determines that there is no unexecuted print job (NO in S14), or if p the determination is NO in S10, the controller 201 ends the reference candidate image registration process.

### Procedure of Reference Image Selection Process

Next, a procedure of a reference image selection process in the printing system 100 will be described. FIG. 13 is a flowchart illustrating the procedure of the reference image selection process in the printing system 100 according to the present embodiment. The process described below is started when a predetermined time elapses after the reference candidate image registration process illustrated in FIG. 12 is completed. Note that the predetermined time is set to, for example, a time required for the ink on the printing sheet to dry and stabilize.

First, the printer controller 1 reminds the operator of the reference image setting (S20). In this step, the printer controller 1 displays the reference image setting reminder screen M3 (see FIG. 5). When the operator presses the “OK” button on the reference image setting reminder screen M3, the reference candidate image selection screen M4 (see FIG. 6) is displayed.

Next, the inkjet printer 2 determines the reference candidate image selected by the operator as the reference image for inspection (S21). In this step, the operator selects the reference image from a plurality of reference candidate images on the reference candidate image selection screen M4 (see FIG. 6). The inkjet printer 2 determines the selected reference candidate image as the reference image, and automatically sets the printing condition setting for printing the reference candidate image.

Next, the inkjet printer 2 deletes the images other than the selected reference candidate images (S22). After the processing of S22, the controller 201 ends the reference image selection process.

### Procedure of Print Product Inspection Process

Next, a procedure of a print product inspection process in the printing system 100 will be described. FIG. 14 is a flowchart illustrating the procedure of the print product inspection process in the printing system 100 according to the present embodiment. Here, it is assumed that the reference image selection process illustrated in FIG. 13 has been executed. It is also assumed that the operator has selected a print job on the job selection screen M1 (see FIG. 3). When the operator sets automatic inspection using a registered reference image on the inspection mode setting screen M2 (see FIG. 4), the following process is started.

First, the controller 201 of the inkjet printer 2 determines whether the automatic inspection using a registered reference image is set (S30).

If the controller 201 determines that the automatic inspection using a registered reference image is not set (NO in S30), the controller 201 ends the print product inspection process.

On the other hand, if the controller 201 determines that the automatic inspection using a registered reference image is set (YES in S30), the controller 201 acquires the selected print job (S31). In this step, the controller 201 acquires the print job selected by the operator on the job selection screen M1 (see FIG. 3).

Next, the controller 201 automatically sets the printing condition setting for the reference image associated with the print job (S32).

Next, the printing section 23 of the inkjet printer 2 performs printing under the automatically set printing condition setting (S33).

Next, the reading section 24 of the inkjet printer 2 reads the printed image and outputs the read image (S34).

Next, the inspection section 202 of the inkjet printer 2 collates the read image of the print product with the reference image associated with the print job of the print product (S35). Then, the inspection section 202 outputs a collation result to the controller 201.

Next, the controller 201 determines whether there is a problem in the collation result (S36).

If the controller 201 determines that there is a problem in the collation result (YES in S36), the controller 201 outputs the print product to the normal sheet ejection tray (S37).

On the other hand, if the controller 201 determines that there is no problem in the collation result (NO in S36), the controller 201 outputs the print product to a sheet ejection tray for disposal (S38).

If the determination is NO in S30, or after the processing of S37 or S38, the controller 201 ends the print product inspection process.

### Effects

As described above, the printing system 100 according to the present embodiment prints a reference candidate each time the printing condition setting is adjusted in order to determine a reference image for inspection. Furthermore, the printing system 100 reads images of the plurality of printed reference candidates without waiting for the ink to stabilize, and registers the read images as reference candidate images. The operator visually checks each reference candidate in which the ink is stabilized and selects a reference image for inspection on the reference candidate image selection screen. The selected reference image and the printing condition setting for the image are registered in association with the print job of the print product. Therefore, when inspecting a print product, the printing system 100 automatically sets the printing condition setting for the reference image and executes the printing. Further, the printing system 100 reads the image of the print product without waiting for the ink to stabilize.

Next, the printing system 100 inspects the print product by collating the read image of the print product with the registered reference image of the print product. The printing system 100 reduces the time of the inspection process by reducing the number of times of waiting for ink to stabilize in the registration process of the reference image for inspection and in the automatic inspection process using the reference image. Therefore, according to the printing system 100 of the present embodiment, it is possible to shorten the inspection time of a print product and improve the efficiency of inspection work.

Note that the present invention is not limited to the above-described embodiment, and various other application examples and modification examples can be adopted without departing from the spirit and scope of the present invention described in the claims.

For example, the embodiment described above is a detailed and specific explanation of the configuration of the printing system to clearly explain the present invention. However, the present invention is not necessarily limited to those including all the described configuration. A part of the configuration of the embodiment described here can be replaced with a configuration of another embodiment. It is also possible to add a configuration of one embodiment to a configuration of another embodiment. Furthermore, it is also possible to add, delete, or replace another configuration for a part of the configuration of the embodiment.

In addition, control lines and information lines considered to be necessary for description are illustrated, and all of the control lines and information lines on a product are not necessarily illustrated. In reality, it may be considered that almost all of the components are coupled to each other. Although the embodiment of the present invention has been described and shown in detail, the disclosed embodiment is made for purposes of illustration and example only and not limitation. The scope of the present invention should be interpreted by terms of the appended claims.

The entire disclosure of Japanese Patent Application No. 2024-037475 filed on Mar. 11, 2024, is incorporated herein by reference in its entirety.

What is claimed is:

1. A printing system comprising:
a printing section that produces a print product by printing an image on a recording material by an inkjet method;
a reading section that reads the image printed by the printing section on the recording material;
a hardware processor that
stores a plurality of reference candidate images which is formed by the printing section printing a plurality of reference candidates for inspecting the print product and the reading section reading the printed plurality of reference candidates without waiting for ink stabilization of the plurality of reference candidates, and
registers a reference candidate image selected from the plurality of reference candidate images as a reference image for inspecting the print product; and
an inspection section that, without waiting for the ink stabilization of the print product, inspects the print product by collating the read image of the print product with the reference image.

2. The printing system according to claim 1, wherein the hardware processor
manages a plurality of printing condition settings for inspecting the print product, and
controls the printing section so that the plurality of reference candidates is printed by automatically selecting the respective plurality of printing condition settings.

3. The printing system according to claim 2, wherein the hardware processor registers the plurality of the reference candidate images and the plurality of printing condition settings for printing the plurality of reference candidate images in association with the print product.

4. The printing system according to claim 3, wherein the hardware processor controls the printing section so that, in a margin of each reference candidate, identification information of the reference candidate is printed.

5. The printing system according to claim 3, wherein
the hardware processor automatically selects one printing condition setting for printing the reference candidate image selected as the reference image, and
the printing section performs printing under the printing condition setting automatically selected by the hardware processor to output the print product.

6. The printing system according to claim 2, further comprising a user interface for setting of the plurality of printing condition settings and selection of the reference candidate image.

7. The printing system according to claim 6, wherein the user interface displays reduced images of the respective plurality of the reference candidate images.

8. The printing system according to claim 6, wherein after a predetermined time for the ink stabilization of the plurality of reference candidates has elapsed, the user interface displays a reminder for the selection of the reference image.

9. The printing system according to claim 6, wherein after the print product is inspected and ink of the reference image is stabilized, the user interface displays a reminder for registration of the reference image.

10. The printing system according to claim 6, wherein the user interface displays a warning when the printing condition setting for printing the print product is different from the printing condition setting automatically selected by the hardware processor.

11. A method for inspecting a print product in a printing system including:
a printing section that produces the print product by printing an image on a recording material by an inkjet method; and
a reading section that reads the image printed by the printing section on the recording material, the method comprising:
storing a plurality of reference candidate images which is formed by the printing section printing a plurality of reference candidates for inspecting the print product and the reading section reading the printed plurality of reference candidates without waiting for ink stabilization of the plurality of reference candidates;
registering a reference candidate image selected from the plurality of reference candidate images as a reference image for inspecting the print product; and,
without waiting for the ink stabilization of the print product, inspecting the print product by collating the read image of the print product with the reference image of the print product.
